(19) United States
(12) Patent Application Publication
(10) Pub. No.: US 2023/0202131 A1
(43) Pub. Date: Jun. 29, 2023

(54) Overlapping Production Method Using Common Rolled Material

(71) Applicant: Yau Cheong LAM, WanChai (HK)

(72) Inventor: Yau Cheong LAM, WanChai (HK)

(21) Appl. No.: 17/988,385

(22) Filed: Nov. 16, 2022

(30) Foreign Application Priority Data
Dec. 27, 2021 (CN) 202111611097.6

(51) Int. Cl. B32B 3/26; B32B 5/26; B32B 5/02; B32B 9/02; B32B 7/08; B32B 38/10; B32B 5/06; B32B 3/12; B32B 37/16; B32B 38/00; B32B 38/18; B23K 26/38; B23K 26/402

(52) U.S. Cl. CPC B32B 3/266; B23K 26/38; B23K 26/402; B32B 3/12; B32B 5/06; B32B 5/022; B32B 5/073; B32B 5/266; B32B 7/08; B32B 9/025; B32B 37/16; B32B 38/0008; B32B 38/10; B32B 38/1808; B23K 2103/34; B32B 2250/20; B32B 2305/20; B32B 2307/732; B32B 2307/748; B32B 2317/08

(57) ABSTRACT

An overlap production method of using standard coiled material, comprising the steps of: selecting a standard coiled material, designing a pattern, laser cutting according to the design pattern, cutting or reserving spaces for inserting drawn strips, forming by staggering and overlapping each layer of standard coiled material, and inserting partial materials of a standard coiled material layer into an adjacent standard coiled material and fixing it with the partial materials of the adjacent standard coiled material, or inserting the drawn strips into the spaces reserved in each layer, and combining the composition and the base clothing to make a product. The present invention produces the product with the above production method by using standard coiled materials instead of thread or strip materials, which not only achieves the goal of higher production efficiency and lower cost, but also makes the finished products have a new staggered material effect.

### FIELD OF THE INVENTION

The present invention relates to the technical field of weaving, in particular to an overlap production method of using standard coiled material.

### BACKGROUND OF THE INVENTION

Weaving in a broad sense refers to the technique of using thread or strip materials to form a flat or three-dimensional structure through a process of repetitive overlapping. The products made through weaving are called knitted or woven products. Weaving in a narrow sense refers to the technique of using yarns that are repeatedly overlapped to form fabrics, clothing, or other items. However, traditional weaving techniques have their disadvantages which are low production and high cost.

Therefore, it is necessary to improve and enhance the prior art.

### SUMMARY OF THE INVENTION

In response to the disadvantages of the prior art, the purpose of the present invention is to provide a new overlap production method of using standard coiled material instead of conventional thread or strip materials, which not only has the advantage of high production efficiency and low cost, but also has a new staggered material effect.

For achieving the above purpose, the technical solution used in the present invention is:
An overlap production method of using standard coiled material, comprising the steps of:
S1. Selecting a standard coiled material that conforms to the design concept;
S2. Designing and planning a pattern of at least two layers of standard coiled material;
S3. Laser cutting according to the design pattern of each layer of standard coiled material;
S4. Cutting or reserving spaces for inserting drawn strips at the interlocking position of each layer of standard coiled material;
S5. Forming by staggering and overlapping each layer of standard coiled material according to the design sequence; and
S6. Inserting partial materials of a standard coiled material layer at the interlocking position into an adjacent standard coiled material interlocking position and fixing it with the partial materials at the interlocking position of the adjacent standard coiled material, or inserting the drawn strips into the spaces reserved in each layer of standard coiled material, and bonding the coiled material composition and the base clothing to make a finished product.

As a further embodiment of the present invention, the standard coiled material is one of fabric, leather, artificial leather, or non-woven fabric.

As a further embodiment of the present invention, the coiled material composition is bonded to the base clothing by one of the following methods, laminating, dissolving, welding, sewing, or embroidering.

As a further embodiment of the present invention, the binding tension of the coiled material composition and the base clothing is not less than 10 N/cm.

As a further embodiment of the present invention, the width and length of the base clothing are greater than other standard coiled materials by more than 10 cm.

Compared with the prior art, the advantages of the present invention are: The present invention produces the products with the above production method by using standard coiled materials instead of thread or strip materials, which not only achieves the goal of higher production efficiency and lower cost, but also makes the finished products have a new staggered material effect.

### BRIEF DESCRIPTION OF THE DRAWINGS

FIG. 1 is a diagram showing a layer of standard coiled material selected for embodiment 1 of the present invention;

FIG. 2 is a diagram showing the interlocking position of each layer of standard coiled material selected for cutting in embodiment 1 of the present invention;

FIG. 3 is a diagram showing the two layers of standard coiled material selected for embodiment 1 of the present invention overlapping according to the design sequence;

FIG. 4 is a diagram showing the finished product made by embodiment 1 of the present invention;

FIG. 5 is a diagram showing a layer of standard coiled material selected for embodiment 2 of the present invention;

FIG. 6 is a diagram showing each layer of standard coiled material selected for embodiment 2 of the present invention reserved for insertion into the space of the drawn strip;

FIG. 7 is a diagram showing the two layers of standard coiled material selected for embodiment 2 of the present invention overlapping according to the design sequence;

FIG. 8 is a diagram showing the finished product made by embodiment 2 of the present invention;

FIG. 9 is a diagram showing a layer of standard coiled material selected for embodiment 3 of the present invention;

FIG. 10 is a diagram showing another layer selected for embodiment 3 of the present invention;

FIG. 11 is a diagram showing the overlap of two layers of standard coiled material selected for embodiment 3 of the present invention; and

FIG. 12 is a diagram showing the finished product made by embodiment 3 of the present invention.

### DESCRIPTION OF THE PREFERRED EMBODIMENTS

The present invention is described in further detail below in conjunction with the accompanying drawings.

### Embodiment 1

The embodiment produces a new material for a package.

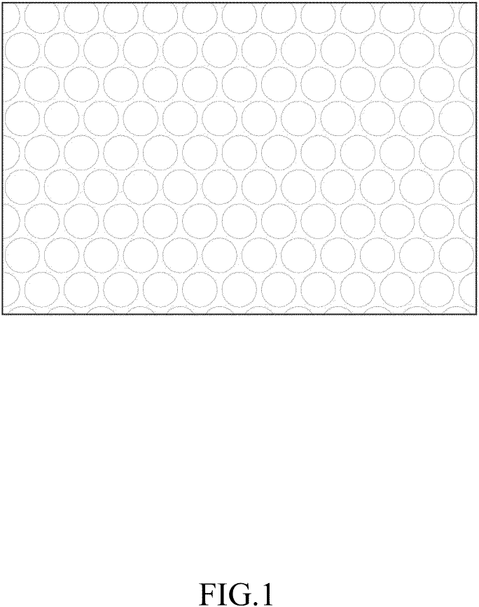

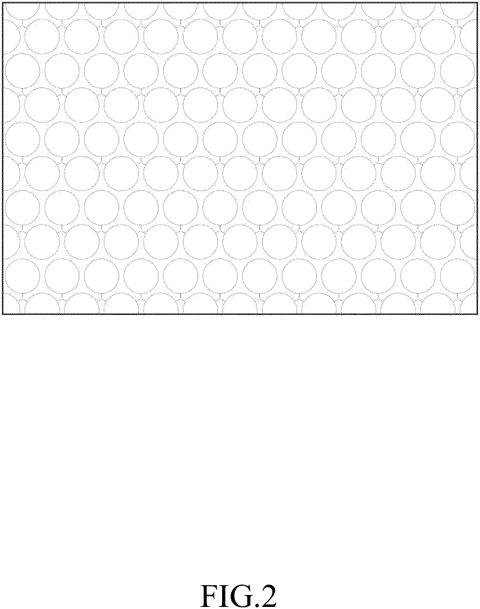

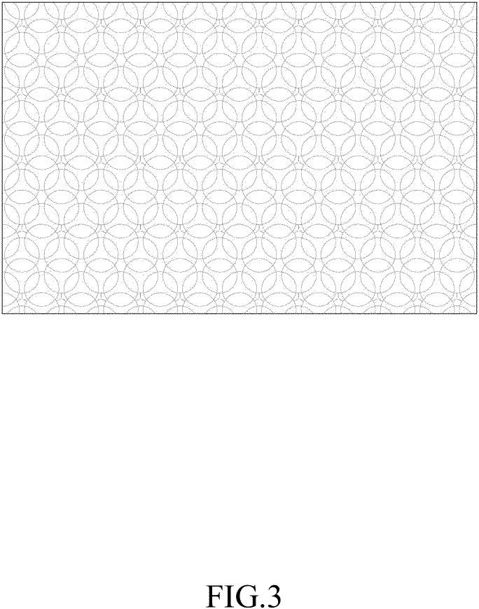

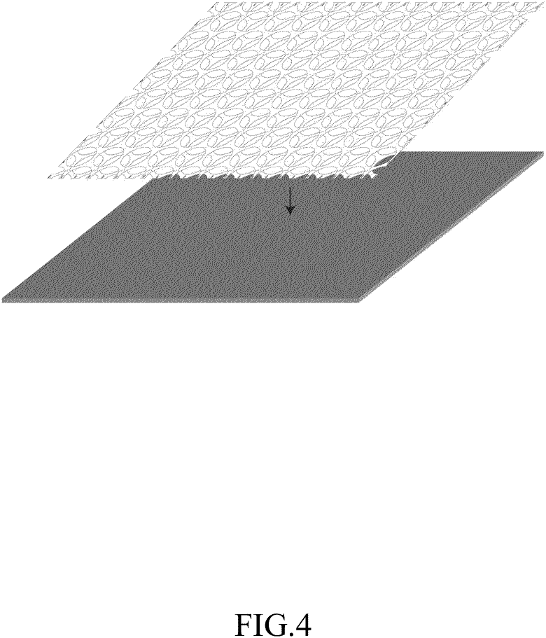

Referring to FIGS. 1-4, a new overlap production method of the present invention using a standard coiled material, comprising the steps of:
S1. Selecting a fabric as the standard coiled material, the fabric conforming to the design concept of the package;
S2. Designing a number of circular pattern units on the fabric, the circular pattern units comprising a number of rows, the rows being set in parallel, the circular pattern units in each row being set at uniform intervals, and the circular pattern units in each row being set staggered with the circular pattern units in adjacent rows;
S3. Laser cutting in accordance with the design patterns;
S4. Cutting at the interlocking position of the fabric, in this embodiment, several rows are divided into a two-by-two group, and the interlocking position is set between the two rows of the group, namely, between a circular pattern unit of one row and two adjacent circular pattern units of another row;
S5. Forming by staggering and overlapping two fabric layers according to the design sequence, and the interlocking position of the same row of one fabric layer is set in a stagger position with the interlocking position of the same row of another fabric layer; and
S6. Inserting partial materials of a fabric layer at the interlocking position into an adjacent fabric interlocking position and fixing it with the partial materials at the interlocking position of the adjacent fabric by means of lamination. The binding tension of the interlocking position of the two fabric layers is 10N/cm, then the finished product can be made.

### Embodiment 2

The embodiment produces a new material for a package.

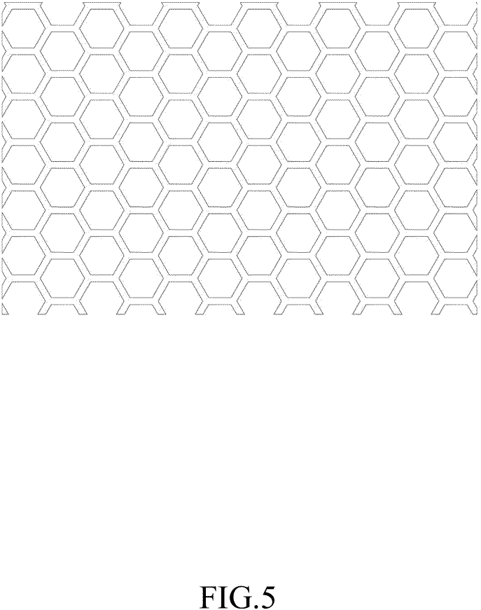

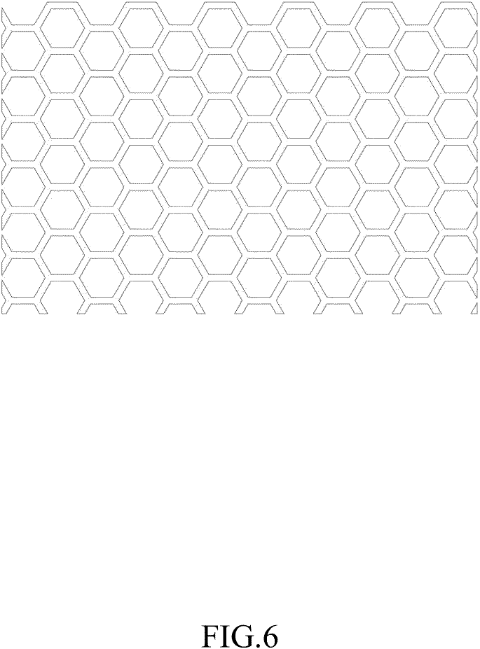

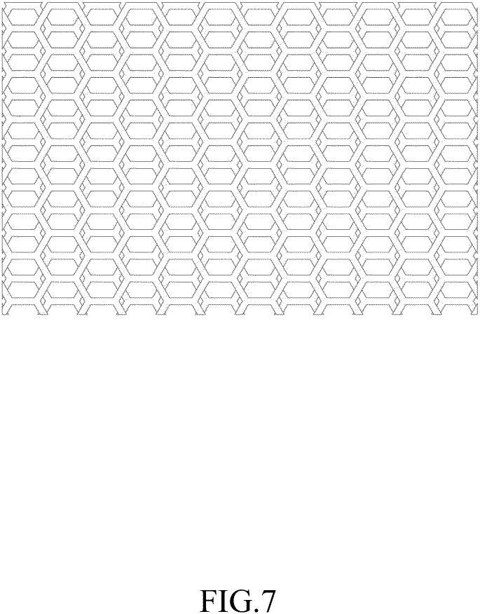

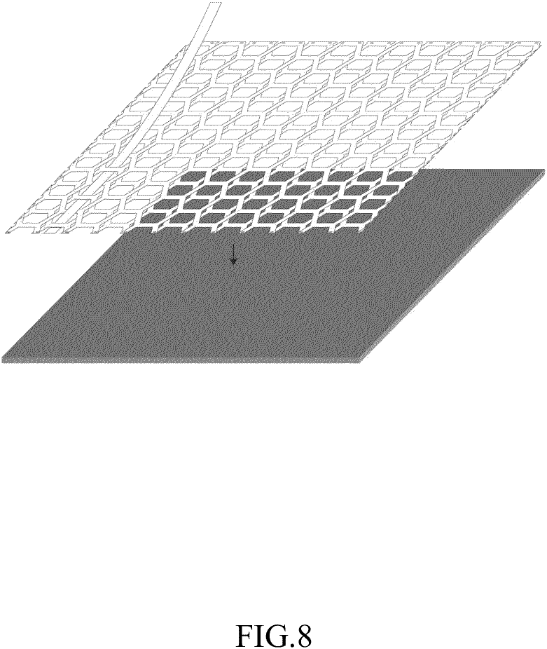

Referring to FIGS. 5-8, a new overlap production method of the present invention using a standard coiled material, comprising the steps of:
S1. Selecting a fabric as the standard coiled material, the fabric conforming to the design concept of a package;
S2. Designing honeycomb hexagonal pattern units on the fabric;
S3. Laser cutting in accordance with the design patterns;
S4. Reserving spaces in each hexagonal pattern unit for inserting drawn strips;
S5. Forming by staggering and overlapping two fabric layers according to the design sequence, and staggered insertion of a draw strip in the space reserved for inserting drawn strips in each row or column of the two fabric layers, and the drawn strip connects each layer of the coiled material.
S6. Binding two layers of fabric that have been connected by the drawn strips with the base clothing by a method of lamination, the binding tension is 10N/cm, then the finished product can be made.

### Embodiment 3

The embodiment produces a new material for a package.

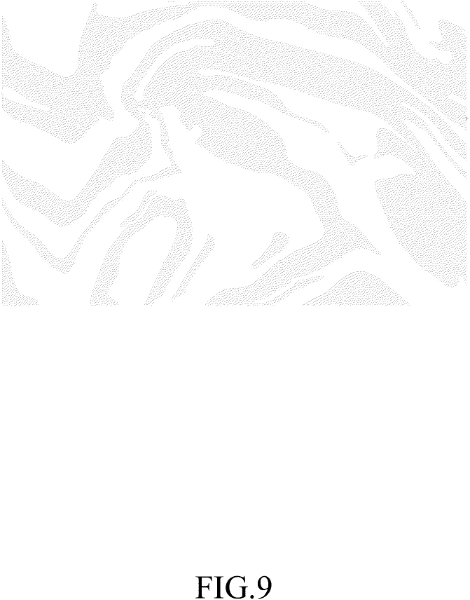

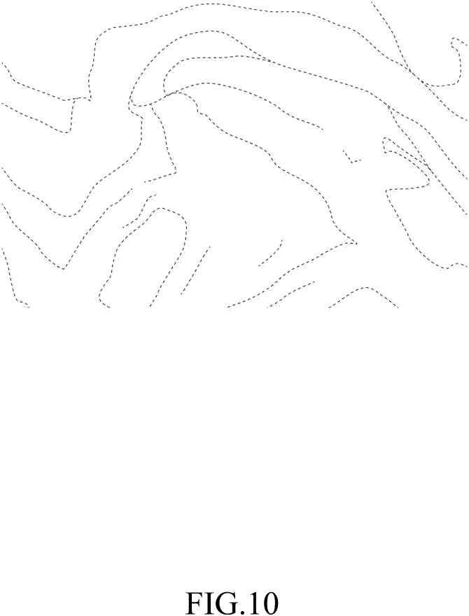

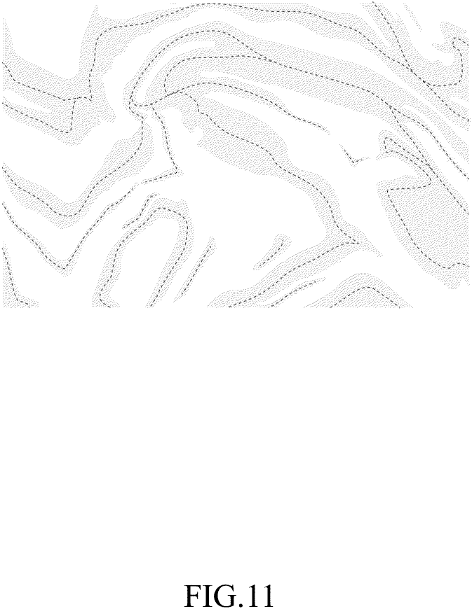

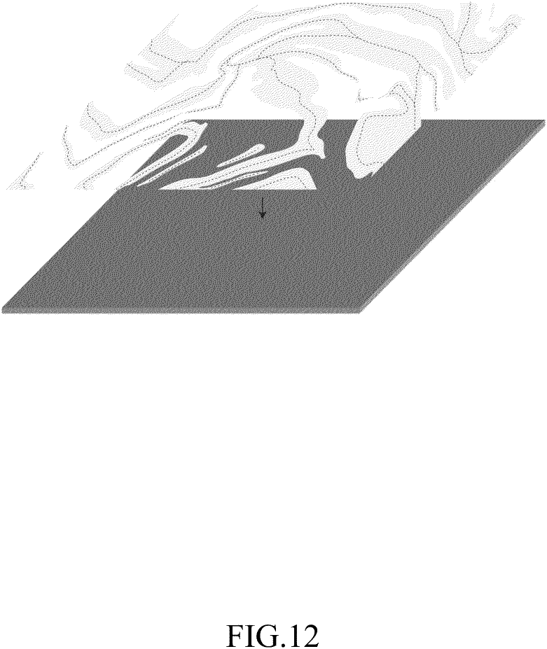

Referring to FIGS. 9-12, a new overlap production method of the present invention using a standard coiled material, comprising the steps of:
S1. Selecting two layers of fabric that conform to the design concept;
S2. Designing and planning a pattern for the two layers of fabric, with an irregular pattern on one fabric layer and an intermediate track corresponding to the irregular pattern on the other fabric layer;
S3. Laser cutting in accordance with the design patterns of each layer of fabric;
S4. Establishing spaces for proceeding with the combination in a preset bonding position and the track of the two fabric layers;
S5. Forming by overlapping each layer of standard coiled material according to the design sequence; and
S6. Binding and fixing two layers of fabric together by dissolving the preset bonding position and the track. By using the dissolution process, the bonding position is slightly concave and pressed, while the unbonded edges are slightly raised up by this process to create a product with a three-dimensional effect.

1. An overlapping production method using common rolled material comprises the steps of:
S1. Selecting a standard coiled material that conforms to the design concept;
S2. Designing and planning a pattern of at least two layers of standard coiled material;
S3. Laser cutting according to the design pattern of each layer of standard coiled material;
S4. Cutting or reserving spaces for inserting drawn strips at the interlocking position of each layer of standard coiled material;
S5. Forming by overlapping each layer of standard coiled material according to the design sequence; and
S6. Inserting partial materials of a standard coiled material layer at the interlocking position into an adjacent standard coiled material interlocking position and fixing it with the partial materials at the interlocking position of the adjacent standard coiled material, or inserting the drawn strips into the spaces reserved in each layer of standard coiled material, and bonding the coiled material composition and the base clothing to make a finished product.

2. The overlapping production method using common rolled material according to claim 1 is characterized in that: the standard coiled material is one of fabric, leather, artificial leather, or non-woven fabric.

3. The overlapping production method using common rolled material according to claim 1 is characterized in that: the coiled material composition is bonded to the base clothing by one of the following methods, laminating, dissolving, welding, sewing, or embroidering.

4. The overlapping production method using common rolled material according to claim 1 is characterized in that: the binding tension of the coiled material composition and the base clothing is not less than 10 N/cm.

5. The overlapping production method using common rolled material according to claim 1 is characterized in that: the width and length of the base clothing are greater than other standard coiled materials by more than 10 cm.
